(19) United States
(12) Patent Application Publication
(10) Pub. No.: US 2017/0246906 A1
(43) Pub. Date: Aug. 31, 2017

(54) TIRE HAVING AN ASYMMETRIC BODY PLY CONSTRUCTION

(71) Applicant: Bridgestone Americas Tire Operations, LLC, Nashville, TN (US)

(72) Inventor: Justin M. Gehres, Uniontown, OH (US)

(21) Appl. No.: 15/507,256

(22) PCT Filed: Sep. 24, 2015
(86) PCT No.: PCT/US2015/051839

§ 371 Date: Feb. 28, 2017

Related U.S. Application Data
(60) Provisional application No. 62/064,788, filed on Oct. 16, 2014.

(51) Int. Cl. B60C 3/06; B60C 15/00

(52) U.S. Cl. CPC B60C 3/06; B60C 15/0045; B60C 2015/009

(57) ABSTRACT

A pneumatic tire may have an outboard bead portion oriented on an outboard side of the tire, an inboard bead portion oriented on an inboard side of the tire, an outboard sidewall portion oriented on the outboard side of the tire, an inboard sidewall portion oriented on the inboard side of the tire, an outboard shoulder portion oriented on the outboard side of the tire, and at least one body ply. The body ply may extend about the outboard bead portion and have a first turnup that extends to at least the outboard shoulder portion. The body ply may extend about the inboard bead portion and have a second turnup that extends to, and terminates in, the inboard bead portion or the inboard sidewall portion, wherein the first turnup height is greater than the second turnup height. At least one belt may be oriented radially outward of the body ply.

### CROSS-REFERENCE TO RELATED APPLICATIONS

### BACKGROUND

In the construction of a tire, one of the many key elements is the body ply. The body ply, which typically comprises reinforcement cord and rubber skim, wraps around the bead bundle (creating a “turnup” portion), passes laterally across the tire, and wraps around the bead bundle on the opposite side (creating another “turnup” portion). The body ply may provide strength to contain the air pressure within the tire, and may additionally provide sidewall impact resistance.

In some applications, it may be desirable to increase the stiffness of one side of a tire without a corresponding increase in the stiffness of the other side of the tire. A tire built with an asymmetric body ply construction, wherein one side of the tire comprises more body plies than the other side of the tire, may have one side that is stiffer than the other side. Furthermore, an asymmetric body ply construction may have the added benefit of keeping the tire's weight and cost to a minimum while providing necessary strength.

What is needed is a tire comprising a plurality of asymmetric body plies, wherein the tire has increased stiffness on the outboard side of the tire without adding unnecessary weight and cost.

### SUMMARY

In one embodiment, a pneumatic tire may have a first bead portion oriented on an outboard side of the tire, a second bead portion oriented on an inboard side of the tire, a first sidewall portion oriented on the outboard side of the tire, a second sidewall portion oriented on the inboard side of the tire, a first shoulder portion oriented on the outboard side of the tire, a first body ply, and a second body ply. The first body ply may extend about the first bead portion and have a first body ply first turnup that extends to at least the first shoulder portion. The first body ply may extend about the second bead portion and have a first body ply second turnup that extends to, and terminates in, the second bead portion or the second sidewall portion. The second body ply may extend about the first bead portion and have a second body ply first turnup that extends to, and terminates in, the first bead portion or the first sidewall portion. The second body ply may extend about the second bead portion and have a second body ply second tumup that extends to, and terminates in, the second bead portion or the second sidewall portion.

In another embodiment, a pneumatic tire may have a first bead portion oriented on an outboard side of the tire, a second bead portion oriented on an inboard side of the tire, a first sidewall portion oriented on the outboard side of the tire, a second sidewall portion oriented on the inboard side of the tire, a first shoulder portion oriented on the outboard side of the tire, a second shoulder portion oriented on the inboard side of the tire, a crown portion, at least one groove, a section height measured in a radial direction from a point adjacent to and radially inward of the first bead portion and second bead portion to a point at a radially innermost portion of the groove, a belt, a first body ply, and a second body ply. The first body ply may extend about the first bead portion and have a first body ply first tumup that extends to a height between about 20% and about 97% of the section height. The first body ply may extend about the second bead portion and have a first body ply second tumup that extends to, and terminates in, the second bead portion or the second sidewall portion. The second body ply may extend about the first bead portion and have a second body ply first turnup that extends to, and terminates in, the first bead portion or the first sidewall portion. The second body ply may extend about the second bead portion and have a second body ply second tumup portion that extends to, and terminates in, the second bead portion or the second sidewall portion.

In another embodiment, a pneumatic tire may have a first bead portion oriented on an outboard side of the tire, a second bead portion oriented on an inboard side of the tire, a first sidewall portion oriented on the outboard side of the tire, a second sidewall portion oriented on the inboard side of the tire, a first shoulder portion oriented on the outboard side of the tire, a second shoulder portion oriented on the inboard side of the tire, a crown portion, a first body ply, and a second body ply. The first body ply may extend about the first bead portion and have a first body ply first turnup portion that extends to about the crown portion of the tire. The first body ply may extend about the second bead portion and have a first body ply second turnup that extends to, and terminates in, at least one of the second bead portion, the second sidewall portion, and the second shoulder portion. The second body ply extends about the first bead portion and have a second body ply first turnup that extends to, and terminates in, at least one of the first bead portion, the first sidewall portion, and the first shoulder portion. The second body ply may extend about the second bead portion and have a second body ply second tumup portion that extends to, and terminates in, at least one of the second bead portion, the second sidewall portion, and the second shoulder portion.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a sectional view of an example arrangement of a tire having an asymmetric body ply construction.

FIG. 2 illustrates a sectional view of an example arrangement of a tire having an asymmetric body ply construction and including a belt.

FIG. 3 illustrates a sectional view of an example arrangement of a prior art tire construction.

### DETAILED DESCRIPTION

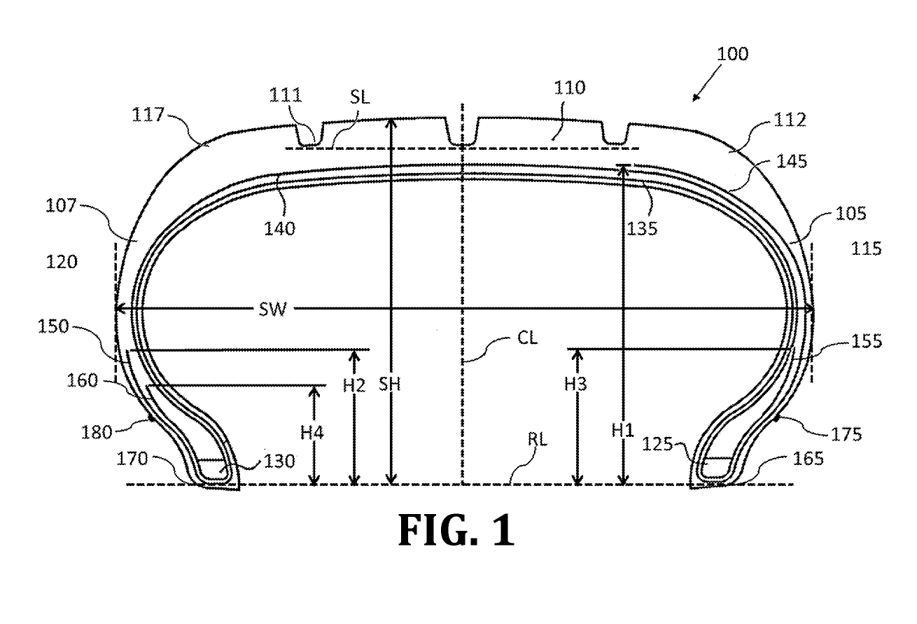

FIG. 1 illustrates a sectional view of an example arrangement of a tire 100 having an asymmetric body ply construction. Tire 100 may include an outboard sidewall portion 105, an inboard sidewall portion 107, a crown portion 110, at least one groove 111, an outboard side 115, and an inboard side 120. Tire 100 may additionally include an outboard bead portion 125 and an inboard bead portion 130. Tire 100 may include a skid line SL oriented laterally along the radially innermost portion of groove 111.

Tire 100 may be a pneumatic tire. Tire 100 may be a pneumatic tire designed for application to a vehicle. Tire 100 may be a pneumatic tire designed for application to a road vehicle. Tire 100 may be a non-directional tire, wherein tire 100 is configured to be mounted on a vehicle without a specified forward rolling direction. Tire 100 may be a uni-directional tire, wherein tire 100 is configured to be mounted on a vehicle with a specified forward rolling direction. Tire 100 may include a designated outboard side 115 and a designated inboard side 120, such that when mounted on a vehicle, outboard side 115 is always oriented away from the centroid of the vehicle, while inboard side 120 is always oriented toward the centroid of the vehicle.

In one embodiment, tire 100 may include a plurality of body plies. Tire 100 may include a first body ply 135 and a second body ply 140. First body ply 135 and second body ply 140 may comprise a reinforcement cord and rubber skim. The reinforcement cord may be a fiber reinforcement cord. The reinforcement cord may be any of a variety of materials, including for example, polyester, rayon, nylon, aramid, and polyethylene naphthalate (PEN). The rubber skim may be any of a variety of rubber materials, having any of a variety of common formulations, densities, and other properties for use in tires. Tire 100 may include body plies in addition to first body ply 135 and second body ply 140.

First body ply 135 may extend about outboard bead portion 125, along outboard sidewall portion 105 in outboard side 115, across crown portion 110, along inboard sidewall portion 107 in inboard side 120, and about inboard bead portion 130. First body ply 135 may comprise a first tumup 145 defined by the portion of first body ply 135 extending about outboard bead portion 125. First body ply 135 may also comprise a second turnup 150 defined by the portion of first body ply 135 extending about inboard bead portion 130. First turnup 145 and second tumup 150 may extend about outboard bead portion 125 and inboard bead portion 130, respectively, and may continue to extend radially outwardly from outboard bead portion 125 and inboard bead portion 130.

Second body ply 140 may extend about outboard bead portion 125 along outboard sidewall portion 105 in outboard side 115, across crown portion 110, along inboard sidewall portion 107 in inboard side 120, and about inboard bead portion 130. Second body ply 140 may comprise a third turnup 155 defined by the portion of second body ply 140 extending about outboard bead portion 125. Second body ply 140 may also comprise a fourth tumup 160 defined by the portion of second body ply 140 extending about inboard bead portion 130. Third turnup 155 and fourth tumup 160 may extend about outboard bead portion 125 and inboard bead portion 130, respectively, and may continue to extend radially outwardly from outboard bead portion 125 and inboard bead portion 130.

Tire 100 may include an outboard side heel point 165 extending circumferentially about outboard side 115 of tire 100. Tire 100 may comprise an inboard side heel point 170 extending circumferentially about inboard side 120 of tire 100. A reference line RL extending between outboard heel point 165 and inboard heel point 170 may be used as a reference for radial measurements in tire 100. Reference line RL may be oriented radially inwardly of outboard bead portion 125 and inboard bead portion 130. Radial measurements in tire 100 extending radially outward of reference line RL shall have a positive number, while radial measurements radially inward of reference line RL shall have a negative number.

In one embodiment, tire 100 may have sidewall portions 105,107 that extend from tire 100's bead portion 125,130 to tire 100's shoulder portion 112,117, respectively. Alternatively, tire 100's sidewall portion 105,107 may extend only a portion of the way between tire 100's bead portion 125,130 and tire 100's shoulder portion 112,117, respectively.

In one embodiment tire 100 may have sidewall portions 105,107 that extend from tire 100's bead portion 125,130 to tire 100's crown portion 110, respectively. Alternatively, tire 100's sidewall portion 105,107 may extend only a portion of the way between tire 100's bead portion 125,130 and tire 100's crown portion 110, respectively.

In one embodiment, tire 100 may have sidewall portions 105,107 that extend 100% of section height SH of the tire. In one embodiment, tire 100's sidewall portion 105,107 may extend along only a portion of section height SH. Tire 100's sidewall portion 105,107 may extend between about 10% and about 90% of section height SH. In one embodiment, tire 100's sidewall portion 105,107 may extend more than 100% of section height SH of the tire. Either of sidewall portion 105 and sidewall portion 107 may extend to different heights.

In one embodiment, tire 100 may have sidewall portions 105,107 which encompass any portion of tire 100 between bead portion 125,130 and the center of crown portion 110.

The sidewalls of a tire, such as sidewall portions 105,107, may deflect when placed under a load. For example, such a load may include the downward force of a vehicle as a result of the acceleration of gravity acting upon the vehicle's mass (i.e. weight), wherein the downward force transmits to the ground through the tires mounted to the vehicle. The sidewalls of a tire may deflect even more dramatically when the tire of a moving vehicle strikes a hard object, such as when impacting the edge of a pothole or a curb. A tire may be constructed with a plurality of body plies, such as body plies 135,140, in its sidewalls to increase the stiffness of the sidewalls. A tire constructed with fewer body plies may have less sidewall stiffness than a tire constructed with a greater number of otherwise identical body plies. When the sidewalls of a tire deflect, the plurality of body plies may deflect dramatically, which may cause the body plies, to break, pinch, or tear. Such destruction of the body plies may weaken the sidewall of the tire and result in the formation of a cut or tear in the sidewall.

Further, breakage of body plies may permit air loss from within the tire to the outside atmosphere. Stated differently, compromising a tire's body plies may result in a compromise to the tire's air retaining ability. Accordingly, weakness in a tire's sidewall due to body ply breakage may increase the risk of air loss. When a vehicle strikes hard objects such as the edges of potholes or curbs, the body plies may break and cause a cut or tear in the sidewall, resulting in catastrophic air loss.

As the stiffness of the sidewall increases, its deflection under load may decrease. A stiffer sidewall may reduce tire deflection and may therefore prevent the body plies of the tire from pinching and subsequently breaking. Maintaining the structural integrity of the body plies may maintain the strength of the sidewall and thus may maintain the tire's internal air pressure.

In one embodiment, tire 100 may include outboard side 115 and inboard side 120. Outboard side 115 may include the side of the tire which is outwardly facing when mounted on a vehicle. In other words, outboard side 115 may be the side furthest from the vehicle upon which the tire is mounted. Inboard side 120 may include the side of the tire which is inwardly facing when mounted on a vehicle. In other words, inboard side 120 may be the side closest to the vehicle upon which the tire is mounted.

A wheel of a motor vehicle (not shown) may include at least a circumferential rim portion, a hub portion, and one or more supports projecting radially from the hub portion and connecting the rim portion to the hub portion. Such a wheel may be constructed wherein the one or more supports are oriented on the hub portion axially outward from the axial center of the hub portion. When the one or more supports are arranged in such a manner, the stiffness of the wheel on its outboard side may be greater than the stiffness of the wheel on its inboard side. This increase in stiffness may be due to the increased material on the outboard side of the wheel relative to the inboard side. As the stiffness of the wheel increases, its corresponding deflection under load may decrease. Thus, an outboard portion of a wheel that is stiffer than the inboard portion of the wheel may deflect less under load than the inboard portion of the wheel.

Under a given load, a tire mounted on a wheel (collectively a “wheel system,” not shown), wherein the wheel system is mounted on a vehicle, may deflect an amount that is relative to the magnitude of the load and the stiffness of the tire. When a wheel has an equal stiffness in both its inboard and outboard sides, it may deflect an equal amount on both sides. As a result, a tire mounted on such a wheel may also deflect an equal amount on both its inboard and outboard sides. However, when a wheel has a higher stiffness on its outboard side than it does on its inboard side, such a wheel may deflect less on the outboard side than it will on its inboard side. To compensate for this unequal deflection, a tire mounted on such a wheel may deflect more on its outboard side than on its inboard side. Such increased deflection may cause the body plies in the outboard sidewall of such a tire to break, pinch, or tear, thereby resulting in air loss from the tire.

Constructing a tire with additional body plies may increase the strength of the tire's sidewalls and may therefore decrease the deflection of the sidewalls under a load. This decreased deflection may result in a lower risk of pinching and consequently less air loss. However, including additional body plies in both sides of a tire may increase the stiffness of the inboard sidewall of the tire more than what is necessary to reduce pinching on the inboard side.

The addition of body plies may also increase the weight of the tire. Including fewer body plies on the inboard side of a tire may allow the tire to be constructed with adequate stiffness without excessive materials and excess weight. Reducing the materials in a tire may reduce the cost of the tire. Reducing a tire's weight may be desirable because excess weight may compromise performance, such as by increasing fuel efficiency and increasing rolling resistance. Adding one or more body plies to only the outboard side of the tire may increase stiffness where it is needed on the outboard sidewall without unnecessarily increasing the weight of the tire and adversely affecting tire performance.

In one embodiment, tire 100 includes total section height SH, which as used herein is the distance between reference line RL of tire 100 and skid line SL of tire 100 when tire 100 is mounted and inflated to specification, without application of a load.

In one embodiment, tire 100 may have a first body ply 135 having an outboard side and an inboard side. The first body ply outboard side may extend axially outward from the centerline CL of crown portion 110, through outboard shoulder portion 112, and may extend radially inward through outboard sidewall portion 105 toward outboard bead portion 125. The first body ply outboard side may extend farther to outboard bead portion 125. The first body ply outboard side may turn about outboard bead portion 125 and extend radially outward to and terminate in outboard sidewall portion 105 at about height H1, thereby creating a first turnup 145. Height H1 may be expressed as a percentage of total section height SH. Calculation of height H1 as a percentage of total section height SH may be performed by the following equation: (height of first turnup 111 (in millimeters)/total section height SH (in millimeters))×100=percentage of total section height SH. First turnup 145 may extend farther through outboard sidewall portion 105 and terminate in outboard shoulder portion 112 at about height H1. First turnup 145 may extend farther yet through both outboard sidewall portion 105 and outboard shoulder portion 112 and terminate in crown portion 110 at about height H1.

The first body ply inboard side may extend axially outward from centerline CL of crown portion 110, through inboard shoulder portion 117, and radially inward through inboard sidewall portion 107 toward inboard bead portion 130. The first body ply inboard side may extend farther to inboard bead portion 130. The first body ply inboard side may turn about inboard bead portion 130 and extend radially outward and terminate in inboard sidewall portion 107 at about height H2, thereby creating a second turnup 150. Height H2 may be expressed as a percentage of total section height SH, wherein height H2 is less than height H1. Second turnup 150 may extend to and terminate in at least one of inboard bead portion 130, inboard sidewall portion 107, and inboard shoulder portion 117, at about a height H2.

In one embodiment, tire 100 may have a second body ply 140 having an outboard side and an inboard side. The second body ply outboard side may extend axially outward from centerline CL of crown portion 110, through outboard shoulder portion 112, and radially inward through outboard sidewall portion 105 toward outboard bead portion 125. The second body ply outboard side may extend farther to outboard bead portion 125. The second body ply outboard side may turn about outboard bead portion 125 and extend radially outward into outboard sidewall portion 105, thereby creating a third turnup 155. Third turnup 155 may terminate in outboard sidewall portion 105 at about height H3. Height H3 may be expressed as a percentage of total section height SH, wherein height H3 is less than height H1. Third turnup 155 may extend to and terminate in at least one of outboard bead portion 125, outboard sidewall portion 105, and outboard shoulder portion 112, at about a height H3.

The second body ply inboard side may extend axially outward from centerline CL of crown portion 110, through inboard shoulder portion 117, and radially inward through inboard sidewall portion 107 toward inboard bead portion 130. The second body ply inboard side may extend farther to inboard bead portion 130. The second body ply inboard side may turn about inboard bead portion 130 and extend radially outward and terminate in inboard sidewall portion 107, thereby creating a fourth tumup 160. Fourth tumup 160 may terminate in inboard sidewall portion 107 at about height H4. Height H4 may be expressed as a percentage of total section height SH, wherein height H4 is less than height H1. Fourth turnup 160 may extend to and terminate in at least one of inboard bead portion 130, inboard sidewall portion 107, and inboard shoulder portion 117, at about a height H4.

In one embodiment, first tumup 145 extends substantially to a height H1, which is expressed as a percentage of total section height SH. In one embodiment, H1 is between about 20% and about 97% of total section height SH of tire 100. In another embodiment, height H1 is between about 30% and about 97% of total section height SH of tire 100. In another embodiment, height H1 is between about 30% and about 94% of total section height SH of tire 100. In another embodiment, height H1 is between about 40% and about 94% of total section height SH of tire 100. Height H1 may be any value within the ranges set forth herein. For example, height H1 may be 42%, 57%, 88%, and the like. Height H1 may be within a range having any of the upper and lower limits set forth herein.

In one embodiment, second tumup 150 extends substantially to a height H2, which is expressed as a percentage of total section height SH. In one embodiment, height H2 is between about 5% and about 82% of total section height SH of tire 100. In another embodiment, height H2 is between about 15% and about 82% of total section height SH of tire 100. In another embodiment, height H2 is between about 15% and about 79% of total section height SH of tire 100. In another embodiment, height H2 is between about 25% and about 79% of total section height SH of tire 100. Height H2 may be any value within the ranges set forth herein. For example, height H2 may be 10%, 38%, 51%, and the like. Height H2 may be within a range having any of the upper and lower limits set forth herein.

In one embodiment, third turnup portion 155 extends substantially to a height H3, which is expressed as a percentage of total section height SH. In one embodiment, height H3 is between about 5% and about 72% of total section height SH of tire 100. In another embodiment, height H3 is between about 10% and about 70% of total section height SH of tire 100. In another embodiment, height H3 is between about 15% and about 69% of total section height SH of tire 100. Height H3 may be any value within the ranges set forth herein. For example, height H3 may be 10%, 38%, 51%, and the like. Height H3 may be within a range having any of the upper and lower limits set forth herein.

In one embodiment, fourth turnup 160 extends substantially to a height H4, which is expressed as a percentage of total section height SH. In one embodiment, height H4 is between about 20% and about 87% of total section height SH of tire 100. In another embodiment, height H4 is between about 25% and about 85% of total section height SH of tire 100. In another embodiment, height H4 is between about 30% and about 84% of total section height SH of tire 100. Height H4 may be any value within the ranges set forth herein. For example, height H4 may be 27%, 38%, 51%, and the like. Height H4 may be within a range having any of the upper and lower limits set forth herein.

In one embodiment, height H1 is greater than each of height H2, height H3, and height H4, wherein at least one of height H2, height H3, and height H4 are different heights. In one embodiment, height H1 is greater than each of height H2, height H3, and height H4, wherein height H3 is greater than each of height H2 and height H4. In one embodiment, height H3 is about equal to height H2. In one embodiment, height H3 is less than height H2. In one embodiment, height H2 is greater than height H4. In one embodiment, height H3 is equal to height H4. In one embodiment, height H1 is greater than height H3, height H3 is greater than height H2, and height H2 is greater than height H4. In one embodiment, height H1 is at least about 15% greater than height H2. In one embodiment, height H1 is at least about 10% greater than height H3. In one embodiment, height H2 is at least about 10% greater than height H4. In one embodiment, height H3 is at least about 5% greater than height H4.

In another embodiment, tire 100 comprises a first rim line 175 and a second rim line 180, wherein a reference line (not shown) extending between first rim line 175 and second rim line 180 may be used as a reference for radial measurements in tire 100. Such measurements include heights H1, H2, H3, and H4.

In one embodiment, tire 100 may include body plies in addition to first body ply 135 and second body ply 140, wherein the additional body plies may each have two sides, wherein each of the two sides of each additional body ply may have a turnup, and wherein each turnup may terminate at a height that is less than height H1.

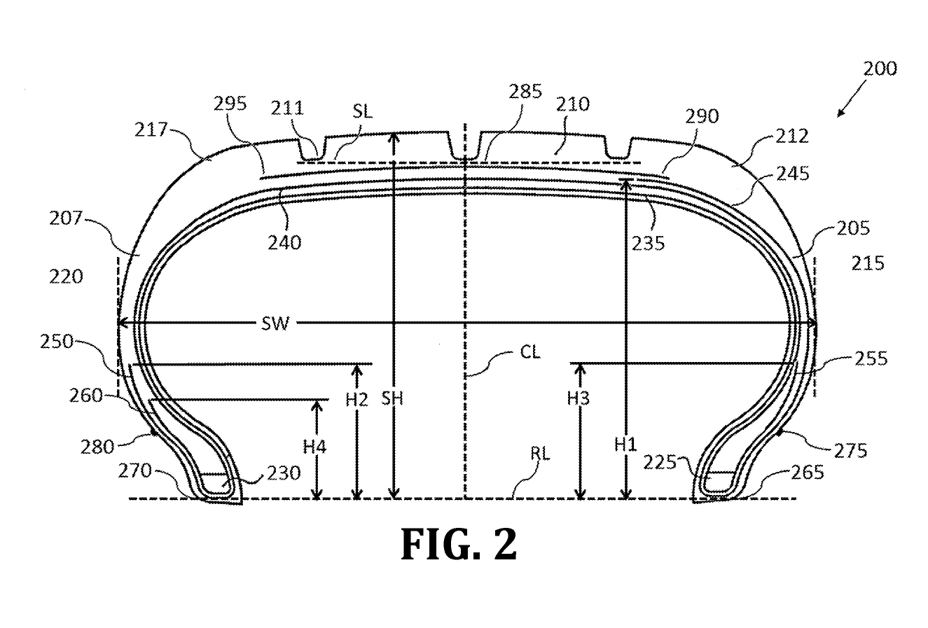

FIG. 2 illustrates a sectional view of an example arrangement of a tire 200 having an asymmetric body ply construction. Tire 200 may have at least one belt 285 oriented circumferentially around tire 200 and oriented within crown portion 210. Tire 200 may also have at least one groove 211. Tire 200 may have a first body ply 235 oriented radially inward from at least one belt 285, wherein first body ply 235 may have an outboard side and an inboard side. The first body ply outboard side may extend axially outward from centerline CL of crown portion 210, through outboard shoulder portion 212, and radially inward through outboard sidewall portion 205 toward outboard bead portion 225. The first body ply outboard side may extend farther to outboard bead portion 225. The first body ply outboard side may turn about outboard bead portion 225 and extend radially outward to and terminate in outboard sidewall portion 205, thereby forming first turnup 245. First turnup 245 may extend to about height H1, expressed as a percentage of total section height SH. First turnup 245 may extend farther through outboard sidewall portion 205 and terminate in outboard shoulder portion 212 at about height H1. First turnup 245 may extend farther yet through both outboard sidewall portion 205 and outboard shoulder portion 212 and terminate radially inward of at least one belt 285 at about height H1. First turnup 245 may terminate radially inward of at least one belt 285 at about the belt outboard side 290 of at least one belt 285, and at about height H1. First turnup 245 may extend farther beyond belt outboard side 290 of at least one belt 285 and terminate radially inward of at least one belt 285 in crown portion 210 at about height H1. First turnup 245 may extend farther yet and terminate radially inward of at least one belt 285 at about the belt inboard side 295 of at least one belt 285 at about height H1. First turnup 245 may extend farther and terminate radially inward of the at least one belt 285 at about the inboard shoulder portion 217 at about height H1.

The first body ply inboard side may extend axially outward from centerline CL of crown portion 210, through inboard shoulder portion 217, and radially inward through inboard sidewall portion 207 toward inboard bead portion 230. The first body ply inboard side may extend farther to inboard bead portion 230. The first body ply inboard side may turn about inboard bead portion 230 and extend radially outward and terminate in inboard sidewall portion 207, thus forming a second turnup 250. Second turnup 250 may terminate at about height H2, expressed as a percentage of total section height SH, wherein height H2 is less than height H1. Second turnup 250 may extend to and terminate in at least one of inboard bead portion 230, inboard sidewall portion 207, and inboard shoulder portion 217, at about a height H2.

In one embodiment, tire 200 may have a second body ply 240 having an outboard side and an inboard side. The second body ply outboard side may extend axially outward from centerline CL of crown portion 210, through outboard shoulder portion 212, and radially inward through outboard sidewall portion 205 toward outboard bead portion 225. The second body ply outboard side may extend farther to outboard bead portion 225. The second body ply outboard side may turn about outboard bead portion 225 and extend radially outward into outboard sidewall portion 205, thereby creating a third turnup 255. Third turnup 255 may terminate in outboard sidewall portion 205 at about height H3, expressed as a percentage of total section height SH, wherein height H3 is less than height H1. Third turnup 255 may extend to and terminate in at least one of outboard bead portion 225, outboard sidewall portion 205, and outboard shoulder portion 212, at about a height H3.

The second body ply inboard side may extend axially outward from centerline CL of crown portion 210, through inboard shoulder portion 217, and radially inward through inboard sidewall portion 207 toward inboard bead portion 230. The second body ply inboard side may extend farther to inboard bead portion 230. The second body ply inboard side may turn about inboard bead portion 230 and extend radially outward and terminate in inboard sidewall portion 207, thereby creating a fourth turnup 260. Fourth turnup 260 may terminated at about height H4, expressed as a percentage of total section height SH, wherein height H4 is less than height H1. Fourth turnup 260 may extend to and terminate in at least one of inboard bead portion 230, inboard sidewall portion 207, and inboard shoulder portion 217, at about a height H4.

In one embodiment, tire 200 may include a first body ply 235 and a second body ply 240, wherein first turnup 245 may extend to a point in outboard side 215 radially inward of the one or more belt 285 and radially outward of second body ply 240.

In one embodiment, tire 200 may include body plies in addition to first body ply 235 and second body ply 240, wherein the additional body plies may each have two sides, wherein each of the two sides of each additional body ply may have a turnup, and wherein each turnup may terminate at a height that is less than height H1.

Heights H1, H2, H3, and H4 may include the values as established above with respect to FIG. 1.

In one embodiment, height H1 is greater than each of height H2, height H3, and height H4, wherein at least one of height H2, height H3, and height H4 are different heights. In one embodiment, height H1 is greater than each of height H2, height H3, and height H4, wherein height H3 is greater than each of height H2 and height H4. In one embodiment, height H3 is about equal to height H2. In one embodiment, height H3 is less than height H2. In one embodiment, height H2 is greater than height H4. In one embodiment, height H3 is equal to height H4. In one embodiment, height H1 is greater than height H3, height H3 is greater than height H2, and height H2 is greater than height H4. In one embodiment, height 111 is at least about 15% greater than height H2. In one embodiment, height H1 is at least about 10% greater than height H3. In one embodiment, height H2 is at least about 10% greater than height H4. In one embodiment, height H3 is at least about 5% greater than height H4.

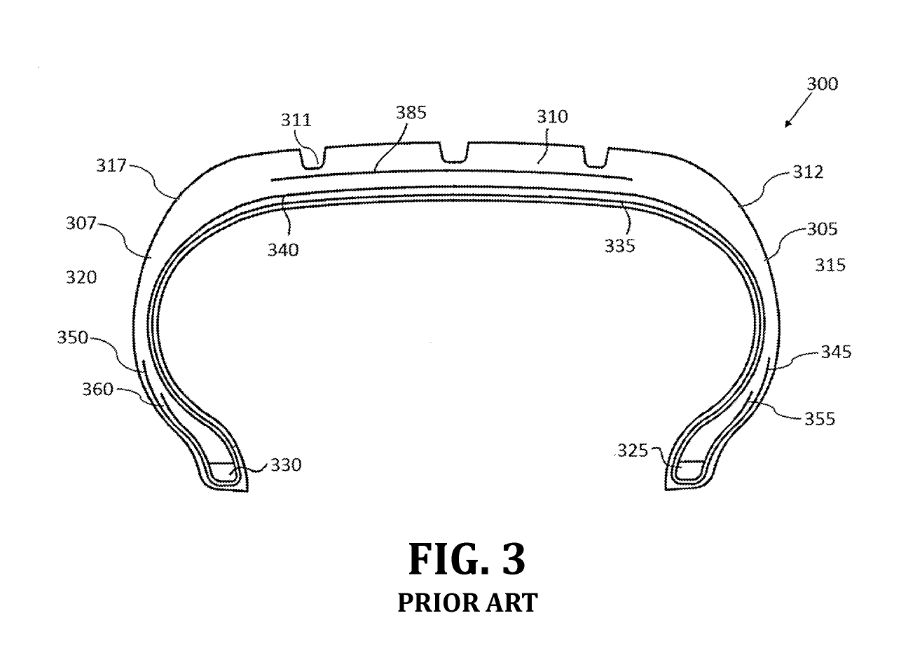

FIG. 3 illustrates a sectional view of an example arrangement of a tire 300 having a prior art construction. Tire 300 may comprise an outboard sidewall portion 305, an inboard sidewall portion 307, a crown portion 310, at least one groove 311, an outboard side 315 and an inboard side 320. Tire 300 may additionally comprise an outboard bead portion 325 and an inboard bead portion 330.

In one embodiment, tire 300 comprises a first body ply 335 and a second body ply 340. First body ply 335 may extend about outboard bead portion 325, along outboard sidewall portion 305 in outboard side 315, across crown portion 310, along inboard sidewall portion 307 in inboard side 320, and about inboard bead portion 320. First body ply 335 may comprise a first tumup 345 defined by the portion of first body ply 335 extending about outboard bead portion 325. First body ply 335 may also comprise a second turnup 350 defined by the portion of first body ply 335 extending about inboard bead portion 330.

Second body ply 340 may extend about outboard bead portion 325 along outboard sidewall portion 305 in outboard side 315, across crown portion 310, along inboard sidewall portion 307 in inboard side 320, and about inboard bead portion 320. Second body ply 340 may comprise a third turnup 355 defined by the portion of second body ply 340 extending about outboard bead portion 325. Second body ply 340 may also comprise a fourth tumup 360 defined by the portion of second body ply 340 extending about inboard bead portion 330.

As illustrated in FIG. 3, in tire 300, first tumup 345 and second turnup 350 comprise substantially the same height, which height is greater than the height of third turnup 355 and fourth turnup 360 (which have substantially the same height).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modem Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±6.35 millimeters (±0.25 inches). To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A pneumatic tire, comprising:
an outboard bead portion oriented on an outboard side of the tire;
an inboard bead portion oriented on an inboard side of the tire;
an outboard sidewall portion oriented on the outboard side of the tire;
an inboard sidewall portion oriented on the inboard side of the tire;
an outboard shoulder portion oriented on the outboard side of the tire; and
a first body ply;
wherein the first body ply extends about the outboard bead portion and has a first turnup that extends to at least the outboard shoulder portion, and
wherein the first body ply extends about the inboard bead portion and has a second turnup that extends to, and terminates in, the inboard bead portion or the inboard sidewall portion.

2. The pneumatic tire of claim 1, further comprising at least one belt, wherein the first body ply is oriented radially inward of the at least one belt, and wherein the first turnup extends to a point radially inward of the at least one belt.

3. The pneumatic tire of claim 1, further comprising a second body ply;
wherein the second body ply extends about the outboard bead portion and has a third turnup that extends to, and terminates in, the outboard bead portion or the outboard sidewall portion,
wherein the third turnup terminates radially inward of the first turnup; and
wherein the second body ply extends about the inboard bead portion and has a fourth turnup that extends to, and terminates in, the inboard bead portion or the inboard sidewall portion, and
wherein the fourth turnup terminates radially inward of the second turnup.

4. The pneumatic tire of claim 3, wherein at least one of the second turnup, the third turnup, and the fourth turnup have different heights.

5. The pneumatic tire of claim 3, further comprising at least one belt, wherein each of the first body ply and the second body ply are oriented radially inward of the at least one belt, and wherein the first turnup extends to a point radially inward of the at least one belt.

6. A pneumatic tire, comprising:
an outboard bead portion oriented on an outboard side of the tire;
an inboard bead portion oriented on an inboard side of the tire;
an outboard sidewall portion oriented on the outboard side of the tire;
an inboard sidewall portion oriented on the inboard side of the tire;
an outboard shoulder portion oriented on the outboard side of the tire;
an inboard shoulder portion oriented on the inboard side of the tire;
at least one groove;
a section height measured in a radial direction from a point adjacent to and radially inward of the outboard bead portion and the inboard bead portion, to a point at a radially innermost portion of the groove; and
a first body ply;
wherein the first body ply extends about the outboard bead portion and has a first turnup that extends to a height between about 20% and about 97% of the section height, and
wherein the first body ply extends about the inboard bead portion and has a second turnup that extends to a height between about 5% and about 82% of the section height.

7. The pneumatic tire of claim 6, wherein at least one of the first turnup extends to a height between about 30% and about 94% of the section height, and wherein the second turnup extends to a height between about 15% and about 79% of the section height.

8. The pneumatic tire of claim 6, wherein the first turnup extends to a height that is at least about 15% greater than the height of the second turnup.

9. The pneumatic tire of claim 6, further comprising at least one belt, wherein the first body ply is located radially inward of the at least one belt, and wherein the first turnup extends to a point radially inward of the at least one belt.

10. The pneumatic tire of claim 6, further comprising a second body ply;
wherein the first body ply extends about the outboard bead portion and has a first turnup that extends to a height between about 30% and about 97% of the section height;
wherein the first body ply extends about the inboard bead portion and has a second turnup that extends to a height between about 15% and about 82% of the section height;
wherein the second body ply extends about the outboard bead portion and has a third turnup that extends to a height between about 20% and about 87% of the section height; and
wherein the second body ply extends about the inboard bead portion and has a fourth turnup that extends to a height between about 5% and about 72% of the section height.

11. The pneumatic tire of claim 10, wherein at least one of 1) the first turnup extends to a height between about 40% and about 94% of the section height, and 2) the second turnup extends to a height between about 25% and about 79% of the section height.

12. The pneumatic tire of claim 10, wherein the height of the first turnup is at least about 15% greater than the height of the second turnup.

13. The pneumatic tire of claim 10, wherein at least one of 1) the height of the first turnup is at least about 10% greater than the height of the third turnup, and 2) the height of the second turnup is at least about 10% greater than the height of the fourth turnup.

14. The pneumatic tire of claim 10, further comprising at least one belt, wherein each of the first body ply and the second body ply are oriented radially inward of the at least one belt, and wherein the first turnup extends to a point radially inward of the at least one belt.

15. A pneumatic tire, comprising:
an outboard bead portion oriented on an outboard side of the tire;
an inboard bead portion oriented on an inboard side of the tire;
an outboard sidewall portion oriented on the outboard side of the tire;
an inboard sidewall portion oriented on the inboard side of the tire;
an outboard shoulder portion oriented on the outboard side of the tire;
an inboard shoulder portion oriented on the inboard side of the tire;
a crown portion; and
a first body ply;
wherein the first body ply extends about the outboard bead portion and has a first turnup portion that extends to, and terminates in, at least one of the outboard sidewall portion, the outboard shoulder portion, and the crown portion; and
wherein the first body ply extends about the inboard bead portion and has a second turnup that extends to, and terminates in, at least one of the inboard bead portion and the inboard sidewall portion.

16. The pneumatic tire of claim 15, further comprising at least one belt, wherein the first body ply is oriented radially inward of the at least one belt, and wherein the first turnup extends to a point radially inward of the at least one belt.

17. The pneumatic tire of claim 15, further comprising a second body ply;
wherein the second body ply extends about the outboard bead portion and has a third turnup that extends to, and terminates in, at least one of the outboard bead portion and the outboard sidewall portion,
wherein the third turnup terminates radially inward of the first turnup;
wherein the second body ply extends about the inboard bead portion and has a fourth turnup that extends to, and terminates in, at least one of the inboard bead portion and the inboard sidewall portion, and
wherein the fourth turnup terminates radially inward of the second turnup.

18. The pneumatic tire of claim 17, further comprising at least one belt, wherein each of the first body ply and the second body ply are oriented radially inward of the at least one belt, and wherein the first turnup extends to a point radially inward of the at least one belt.

19. The pneumatic tire of claim 18, wherein the at least one belt comprises an outboard portion, and wherein the first turnup extends to about the at least one belt outboard portion.

20. The pneumatic tire of claim 18, wherein the at least one belt comprises an outboard portion, and wherein the first turnup extends axially inward of the at least one belt outboard portion.
